(19) United States
(12) Patent Application Publication
(10) Pub. No.: US 2022/0404450 A1
(43) Pub. Date: Dec. 22, 2022

(54) POSITIONING OF A WIRELESS COMMUNICATION DEVICE

(71) Applicant: Sony Group Corporation, Tokyo (JP)

(72) Inventors: Anders BERGGREN, Lund (SE); Torgny PALENIUS, Barsebäck (SE); Lars NORD, Lund (SE)

(21) Appl. No.: 17/775,278

(22) PCT Filed: Nov. 16, 2020
(86) PCT No.: PCT/EP2020/082230

§ 371 Date: May 7, 2022

(30) Foreign Application Priority Data
Nov. 15, 2019 (SE) 1930375-9

(51) Int. Cl. G01S 5/00; H04W 64/00; H04W 74/08

(52) U.S. Cl. CPC G01S 5/0018; H04W 64/00; H04W 74/0833

(57) ABSTRACT

A method of operating a wireless communication device (101) attachable to a communications network (100) includes receiving a message (6000, 6002) from the communications network (100), the message (6000, 6002) being indicative of a request for a location report (6009) of the wireless communication device (101), and upon receiving the message (6000, 6002) and based on a positioning measurement, transmitting an uplink message (6003) of a random-access procedure (600) of the wireless communication device (101), the uplink message (6003) comprising the location report (6009).

### TECHNICAL FIELD

Various examples of the invention relate to a mobile device providing a location report.

### BACKGROUND

Positioning measurements of a position of mobile devices are applied in various fields. Examples include location-based services, geo-tracking, navigation, smart-factory, Internet of Things (IoT) applications, emergency services, etc.

Sometimes, positioning measurements are combined with wireless communication. Here, downlink (DL) positioning reference signals (PRSs) are transmitted by a plurality of base stations (BS) of a cellular network (NW) and received by a mobile device (or wireless communication device; UE). Based on a receive property of the PRSs—e.g., Time Difference Of Arrival (TDOA) and/or path loss, etc.—it is possible to determine the position of the UE. Multilateration can be performed, based on the TDOA of PRSs transmitted by multiple BSs. A respective location report can be transmitted to the cellular NW using a positioning protocol (PP).

Details with respect to the PP for obtaining the location report are described in the Third Generation Partnership Project (3GPP) Technical Specification (TS) 23.273 V16.0.0 (2019-06), e.g., section 6.11.1, for the 3GPP 5G New Radio (NR) protocol; and for 3GPP 4G Long Term Evolution (LTE) protocol in 3GPP TS 36.355 V15.0.0 (2018-06), e.g., section 5.3.2.

Existing implementations of the control signalling according to the PP to provide the location report require significant time, i.e., introduce latency until obtaining the location report. Also, existing implementations of the control signalling according to the PP require significant control signaling, thus occupying the spectrum.

### SUMMARY

Accordingly, there is a need for advanced implementations of controlling signalling to providing a location report. In particular, there is a need for PPs which mitigate or overcome at least some of the above-identified restrictions or drawbacks.

This need is met by the features of the independent claims. The features of the dependent claims define embodiments.

According to various examples, it is possible to perform a positioning measurement while the UE transitions from an idle mode to a connected mode. In particular, the positioning measurement can be performed while a random-access procedure is ongoing.

This facilitates providing a location updates even before the UE has completed the transition towards the connected mode.

According to the various examples described herein, the location update can be implemented using a location report. It is possible that the location report is included in an uplink message of the random-access procedure. The location report is generally optional. Some positioning techniques, e.g., transmission of uplink PRSs may not require a location report.

In some scenarios, it may be helpful to assist the UE in the positioning measurement. Here, configuration information for the positioning measurement may be provided to the UE. According to examples, it is possible that the configuration information is included in a downlink message of the random-access procedure.

A method of operating a UE attachable to a communications NW includes receiving a request for a location report of the UE and, upon receiving the request for the location report, executing a positioning measurement. The positioning measurement is executed while transitioning from operation of the UE in an idle mode towards operation of the wireless communication in a connected mode.

A method of operating a UE that can be connected to a communications NW includes receiving a configuration for a positioning measurement to be executed by the UE while transitioning from an operation of the wireless communication device in an idle mode towards operation of the wireless communication in a connected mode. The configuration can be received while operating the UE in an idle mode. A broadcasted message may be used or a paging message or a downlink message of a random-access procedure.

Transitioning the operation of the UE from the idle mode towards the connected mode can include participating in a random-access procedure. The random-access procedure can include signaling of one or more uplink messages and/or signaling of one or more downlink messages. A random-access preamble can be signaled in the uplink direction.

A method of operating a UE that is attachable to a communications network includes receiving a message from the communications network. The message is indicative of a request for a location report of the UE. The method also includes transmitting an uplink message of a random-access procedure of the UE upon receiving the message and based on a positioning measurement. The uplink message includes the location report.

For example, the message may be a broadcasted message or a downlink message.

A computer program or a computer-program product or a computer-readable storage medium includes program code. The program code can be loaded by a least one processor and the at least one processor can execute the program code. Executing the program code causes the at least one processor to perform a method of operating a UE that is attachable to a communications network. The method includes receiving a message from the communications network. The message is indicative of a request for a location report of the UE. The method also includes transmitting an uplink message of a random-access procedure of the UE, upon receiving the message and based on a positioning measurement. The uplink message includes the location report.

A UE includes control circuitry configured to receive a message from a communications network to which the UEs attachable. The message is indicative of a request for location report of the UE. The control circuitry is further configured to transmit an uplink message of a random-access procedure upon receiving the message and based on the positioning measurement. The uplink message includes the location report.

A method of operating a node of a communications network includes transmitting a message to a UE. The message is indicative of a request for location report of the UE. The method also includes, upon transmitting the message, receiving an uplink message of a random-access procedure of the UE. The uplink message includes the location report.

For example, the request can be for location reports of multiple UEs attachable to the communications network. For example, the request can be for location reports of UEs in a certain cell of the communications network and/or having a certain category.

A computer program or a computer-program product or a computer-readable storage medium includes program code. The program code can be loaded by at least one processor. The least one processor can execute the program code. Upon executing the program code, the least one processor can perform a method of operating a node of a communications network. The method includes transmitting a message to a UE. The message is indicative of a request for a location report of the UE. The method further includes, upon transmitting the message, receiving an uplink message of a random-access procedure of the UE. The uplink message includes the location report.

A node of a communications network includes control circuitry. The control circuitry is configured to transmit a message to a UE. The message is indicative of a request for a location report of the UE. The method also includes, upon transmitting the message, receiving an uplink message of a random-access procedure of the UE. The uplink message includes the location report.

A method of operating a UE includes receiving a downlink message while transitioning the UE from operation in an idle mode to a connected mode. The downlink message is indicative of control information for a positioning measurement. The method further includes performing the positioning measurement while transitioning from the operation in the idle mode towards the connected mode. For example, the downlink message may be a message of a random-access procedure triggered by receipt of a random-access preamble transmitted by the UE. For example, the downlink message may be an extension to such message of the random-access procedure, and may be transmitted on time-frequency resources indicated by a downlink scheduling assignment included in the message of the random-access procedure.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular NW according to various examples.

FIG. 2 schematically illustrates a connected mode and an idle mode in which a UE that is attachable to the cellular NW can operate according to various examples.

FIG. 3 schematically illustrates a random-access procedure including an early location report according to various examples.

FIG. 4 schematically illustrates a BS according to various examples.

FIG. 5 schematically illustrates a location management function according to various examples.

FIG. 6 schematically illustrates a UE according to various examples.

FIG. 7 is a flowchart of a method according to various examples.

FIG. 8 is a flowchart of a method according to various examples.

FIG. 9 is a signaling diagram according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques associated with determining a position of a UE are described. To facilitate the determining of the position of the UE, the UE may provide a location report. Based on the position, position-dependent services can be implemented. Examples include geo-messaging, geo-tracking, smart-factory, autonomous driving, emergency rescue or other emergency services, etc.

There are various options available for implementing the location report. As a general rule, the location report may be directly indicative of the position of the UE. For instance, the location report may specify the position of the UE in a global coordinate system such as WGS84. Alternatively or additionally, the location report may specify the position of the UE with respect to anchor positions, e.g., defined by access nodes which, in turn, may have a well-defined position in a global coordinate system.

Sometimes, the UE may be configured to determine the position of the UE; here, the location report may include the determined position. In other examples, at least parts of such determining of the position of the UE may not be performed by the UE, but by another node. In such a scenario, the location report may be indicative of information that enables the other node—e.g., a location server node—to infer the position of the UE, e.g., based on calculation. For instance, the location report may include measurement data of positioning measurements executed by the UE. To give an example, it would be possible that the location report is indicative of the TDOA of positioning reference signals transmitted by multiple access node; then, multilateration can be performed by the location server node.

As a general rule, in the techniques described herein, various types of positioning measurements may be employed. For example, it would be possible to use PRSs that are transmitted by multiple access nodes of a communication system, the access nodes having a well-defined (relative) position. Then, e.g., based on TDOA, it is possible to determine the position of the UE. Alternatively or additionally to such PRS-based positioning measurements, non-PRS-based positioning measurements are conceivable. Such techniques may rely on satellite positioning using unidirectional transmission by the satellites. Alternatively or additionally, sensors of the UE can be used to determine its movement with respect to the environment. For example, an accelerometer may be used. These are just a few examples, and different types of positioning measurements can be relied upon in the various examples described herein. The particular type of positioning measurement to be used is not germane for the functioning of the control signaling described in the various examples herein.

As a general rule, it would be possible that the type of the positioning measurement to be used by the UE is configured by the NW. For example, the NW may transmit, to the UE, a control message that is indicative of the type of the positioning measurement to be used. In other examples, the UE may select the particular type of positioning measurement to be used.

Various aspects relate to a communication system. For example, the communication system may be implemented by a UE and an access node of a communication NW. For example, the access node may be implemented by a BS of a cellular NW. Example NW architectures include the 3GPP Long Term Evolution (LTE) (4G) or New Radio (NR) (5G) architecture. Hereinafter, for sake of simplicity various examples will be described in connection with an implementation of the communication system by a UE connectable to a cellular NW. However, similar techniques may be readily employed for other kinds and types of communication systems.

The cellular NW may provide a wireless link between the UE and the BS. Downlink (DL) signals may be transmitted by the BS and received by the UE. Uplink (UL) signals may be transmitted by the UE and received by the BS. DL PRSs may be transmitted.

Hereinafter, techniques related to a random-access (RA) procedure of a UE connecting to a NW are described. The RA procedure is used to transition from operating the UE in an idle mode—in which a data connection between the UE and the cellular NW is not established—to operating the UE in a connected mode—in which the data connection is established. For example, the 3GPP 4G and 5G protocols employ a RA procedure including four messages exchanged between the UE and the BS (4-step RA procedure). However, the techniques described herein are not limited to a four-step random-access procedure. Other initial access procedures are also applicable, including but not limited to UE initiated access procedures with more or a smaller number of signaling steps.

According to examples, in a RA procedure, a UE transmits an UL RA message, e.g., upon receiving a paging message. The UL RA message includes a RA preamble. The UL RA message which includes the RA preamble is also referred to as RA message 1 (RAmsg1). The RA preamble as used herein may be implemented by a pattern or signature (preamble sequence). There is a risk of contention if two or more UEs transmit on the same resource blocks using the same preamble sequence. The particular choice of the preamble sequence may facilitate distinguishing between different UEs. The RA preamble sequence may be selected from a set of candidate preamble sequences (preamble partition), e.g., 64 or 128 candidate preambles. The different candidate preamble sequences may use orthogonal codes. Upon receiving the RAmsg1, the BS transmits a RA response (RAmsg2). The RAmsg2 includes an UL scheduling grant. Using the UL scheduling grant, the UE sends an RRC connection request message (RAmsg3). The UL scheduling grant is indicative of time-frequency resources of a time-frequency resource grid of a wireless link of the cellular NW allocated to the UE for the transmission of the RAmsg3. As part of the RAmsg3, the UE uniquely identifies itself. There is still the risk of contention between the UEs that initiated the RA procedure, but if one of the transmissions is stronger than the others, then the BS will be able to decode it. The other transmissions will cause interference. The BS sends an RRC connection response message (RAmsg4) including an acknowledgement and echoing back the RAmsg3, so it includes the identity of the successful UE. Thus, the contention may be resolved and a data connection may be established.

Various techniques described herein relate to transmitting the location report during the RA procedure. The location report can be included in an UL message of the RA procedure. For example, the location report can be piggybacked onto the UL message of the RA procedure. For example, the location report can be included in the RAmsg3. For this, concepts according to payload transmission during the RA procedure sometimes referred to as early data transmission (EDT) can be used. According to techniques described herein, it is not required to complete the establishment of the data connection prior to communicating the location report. Hereinafter, such a location report transmitted early on, during the RA procedure is referred to as early location report (ELR).

An example implementation is described for 3GPP 4G in 3GPP TS TS 36.331, Version 15.6.0, section 5.3.3.3b.

To be able to provide the ELR, the underlying positioning measurement may be executed while transitioning from operating the UE in the idle mode towards operating the UE in the connected mode. In other words, it may be possible that the positioning measurement is executed while the RA procedure is still ongoing. The positioning measurement may be executed in parallel to the RA procedure.

According to examples, the ELR may be triggered by the UE. For instance, there may be a timing scheme monitored at the UE which triggers repetitive ELRs. In a further example, the ELR may be triggered by UE mobility. For example, if the UE detects that it has moved—e.g., based on a positioning measurement or by receiving a new cell identity—it may trigger the ELR. Alternatively, the ELR may be NW-triggered: According to examples, the cellular NW can trigger a location update, i.e., request an ELR from the UE. This can, in some scenarios, be done as part of paging. For example, a core NW entity of the cellular NW could transmit a paging request message to the radio access NW (RAN) of the cellular NW, the paging request message having a paging cause value “location”. Based on this paging cause value, the RAN can include extra information in the paging message transmitted on the wireless link and to be decoded by the UE. Thereby, the paging message can be indicative of the request for the ELR. Such extra information in the paging message could be a single bit or multi-bit information element. Such extra information can indicate the paging cause value “location”; alternatively or additionally, the extra information can indicate the type of positioning measurement to be used, and/or configuration information for PRSs. There are also other options available for implementing the request for the ELR. For instance, it would be possible that the RAmsg2 is indicative of the request for the ELR. For example, the RAmsg2 may include a respective indicator. The RAmsg2 may also be indicative of the type of the positioning measurement. Alternatively or additionally, the request for the ELR may be included in a broadcasted information block. Thereby, it would be possible to request the ELR from multiple UEs using a single message.

As mentioned above, scenarios are conceivable in which the positioning measurement relies on the transmission of PRSs. As a general rule, it would be possible to use UL PRSs and/or DL PRSs. It would be possible that the cellular NW provides, to the UE, configuration information of the UL and/or DL PRSs during the RA procedure such that the UE can then transmit and/or received the PRSs in accordance with the configuration information. According to examples, the RAmsg2 may include a DL scheduling assignment for a DL configuration message that, in turn, includes configuration information for UL and/or DL PRSs. The configuration information could also be directly included in the RAmsg2. Accordingly, the configuration information for PRSs can be provided to the UE even before operating in the connected mode.

Depending on the scenario, the configuration implementation can be implemented differently. For example, the configuration information may be indicative of time-frequency resources on which the UE should transmit and/or receive PRSs. The configuration information for the DL PRSs may, e.g., include a list of cells or more BSs of the cellular NW transmitting the PRSs. Alternatively or additionally, the configuration information can include time-frequency resources allocated for the transmission of the PRSs, e.g., for each one of the cell/BSs that are configured to transmit the PRSs. The configuration information could also be indicative of spatial resources: For example, beam information could be indicated. For instance, some beams of the BS may carry DL PRSs, while other beams may not. The configuration information could also be indicative of timing offsets of the cells/BSs that transmit the PRSs. For example, it would be possible that the cellular NW selects those cells/BSs that are configured to transmit the PRSs depending on the particular serving BS of the cellular NW that receives the RAmsg1 from the UE. For instance, it may be possible to select those cells/BSs that are in the vicinity of the serving BS, in addition to the serving BS itself. More generally speaking, it would be possible that the configuration information for the PRSs is determined based on the serving BS.

Thus, it would be possible that the UE transmits and/or monitors for PRSs even before completing the RA procedure. Thus, the positioning measurement can be performed while transitioning from the idle mode towards the connected mode. This can be used to complete the positioning measurement based on the PRSs even before completing the RA procedure. As a general rule, it is not required that this transition towards the connected mode is to be completed. For instance, the transition may be aborted and the UE may fall-back to the idle mode.

Then, it would be possible in some scenarios that the ELR is transmitted as part of the RA procedure to the cellular NW (in other examples, the location report may be triggered after completion of the RA procedure, or may not be required at all, e.g., in case of UL PRSs). For example, the ELR could be included as an EDT piggybacked to the RAmsg3.

To accommodate for the positioning measurement, it is possible that the cellular NW postpones/delays the time at which the UE has to transmit the RAmsg3 including the ELR to the cellular NW, if compared to reference implementations. A corresponding UL scheduling grant can be included in the RAmsg2. Then, the time delay between RAmsg2 and RAmsg 3 as defined by the UL scheduling grant can be increased, compared to reference implementations. For example, the time delay may be in the range of 10 ms to 500 ms.

In some examples, it would be possible that two sets of time-frequency resources are provided by the cellular NW for the transmission of the RAmsg3. The UL scheduling grant included in the RAmsg2 can be indicative of these two sets. As such, two parts of the UL scheduling grant can be provided or two instances of the UL scheduling grant can be provided. In some scenarios, two UL scheduling grants can be provided. The two sets of time-frequency resources can be offset in time domain from each other, by a respective time delay. A first set of time-frequency resources can be comparably close in time domain to the transmission of the RAmsg2, e.g., such that the time delay is in the range of 2 ms to 10 ms. A second set of time-frequency resources can be delayed, e.g., so that the time delay is in the range of 10 ms to 200 ms, or even up to 500 ms, optionally up to 5 seconds. By such larger time delays, it becomes possible to accommodate for the positioning measurement to be executed during the time delay.

As a general rule, different types of positioning measurements may require a different time for execution: It would be possible that the cellular NW determines/dimensions the time delay based on the type of positioning measurement to be used by the UE. Alternatively or additionally, such time delay may be required to inform neighbouring BSs of the time-frequency resources for transmitting PRSs. Also, in such a scenario it may be helpful to delay the transmission of the ELR.

As a general rule, it would be possible that the UE selects between the two sets of time-frequency resources. This selection can be dependent on whether the UE requires to execute a further positioning measurement, as will be explained below. Thus, it would be possible that the UE either uses the first set of time-frequency resources for the transmission of the RAmsg3, or uses the second set of time-frequency resources for the transmission of the RAmsg3. In such scenarios in which the UE selects either the first set of time-frequency resources, or the second set of time-frequency resources, if the cellular network receives the RAmsg3 on the first set of time-frequency resources, it can free-up the allocation on the second set of time-frequency resources and use these time-frequency resources for another UE. In other examples, it would be possible that the RAmsg3 is transmitted twice, on both sets of time-frequency resources. Information elements included in the RAmsg3 transmitted at the two sets of time-frequency resources can then vary.

Scenarios are conceivable in which the UE can forego executing the positioning measurement, even if requested to do so by the cellular NW. For example, the UE may have a reduced/low mobility level. Such a scenario may be conceivable for, e.g., a smart-meter or other static device such as a non-moving cellular phone. Then, due to the low mobility level, an earlier positioning measurement—executed before receiving the request from the cellular NW for the location update—may thus be still valid. This means that the earlier positioning measurement may be indicative of the position of the UE with an acceptable accuracy. The UE and/or the NW may have available a stored version of the location report associated with this earlier positioning measurement. Then, it is not required to re-execute the positioning measurement, but it is rather possible to rely on the stored version of the location report. In such a scenario, the UE may indicate to the cellular NW that the earlier positioning measurement is still valid. Such indication to the cellular NW may be explicit or may be implicit. For instance, an implicit indication could be implemented by the UE by selecting the first set of time-frequency resources for the transmission of the RAmsg3. The selection may e.g. be based on the mobility level and/or the availability of the stored version of the location report. In some other embodiments the UE includes a respective indicator indicating the validity of the earlier positioning measurement in the RAmsg3 transmitted using the first set of time-frequency resources, as explicit indication.

A few example scenarios regarding the use of the first and second sets of time-frequency resources are illustrated in Table 1 below.

TABLE 1
Options for using first and second sets of time-
frequency resources for RAmsg3 transmission

| | First set of | Second set of | |
|---|---|---|---|
| | t-f resources | t-f resources | Explanation |
| A | RAmsg3, no | not used | UE implicitly indicates to |
| | piggybacked | | cellular NW that the earlier |
| | data | | ELR is still valid. Cellular |
| | | | NW can load earlier ELR. |
| B | RAmsg3, ELR | not used | UE includes an explicit |
| | validity | | indicator indicating the validity |
| | indicator | | of the earlier positioning |
| | piggybacked | | measurement. Cellular NW |
| | | | can load earlier ELR. |
| C | RAmsg3, ELR | not used | UE has a valid positioning |
| | piggybacked | | measurement and/or stored |
| | | | valid ELR available. No need |
| | | | to re-execute positioning |
| | | | measurement. Fast |
| | | | provisioning of ELR possible. |
| D | not used | RAmsg3, ELR | Positioning measurement |
| | | piggybacked | needs to be re-executed. ELR |
| | | | included in the RAmsg3 upon |
| | | | selecting the second set of |
| | | | time-frequency resources. |
| E | RAmsg3 | RAmsg3, ELR | Positioning measurement |
| | including | piggybacked | needs to be re-executed. ELR |
| | some other | | included in the RAmsg3 upon |
| | EDT | | selecting the second set of |
| | | | time-frequency resources. UE |
| | | | can include some other UE- |
| | | | originating UL data in |
| | | | RAmsg3 on first set of t-f- |
| | | | resources. |
| F | As option A, | RAmsg3 | UE can include some other |
| | B, or C | including | UE-originating UL data in |
| | | some other | RAmsg3 on second set of t-f- |
| | | EDT | resources. |

It would be possible that the reception of the ELR by the cellular NW is acknowledged in the RAmsg4; then, there may be no need to complete the establishing of the data connection. Rather, the data connection establishment can be aborted. The UE can transition back to the idle mode. But there are also scenarios conceivable in which there is further data to be transmitted, e.g., UE-originating data. The data may or may not be related to the ELR. For example, sometimes, the data size of the ELR can be comparably large. In such a case, the UE can request allocation of additional time-frequency radio resources on an UL channel of the data connection. In this case, the cellular NW can continue the establishment of the data connection and transition into operation in the connected mode. This can include transmission of a DL RA message for the connection setup and an UL RA message confirming the completion of the setup of the connection. Then, the UE has transitioned into a connected mode and the remaining UL data can be transmitted using the data connection.

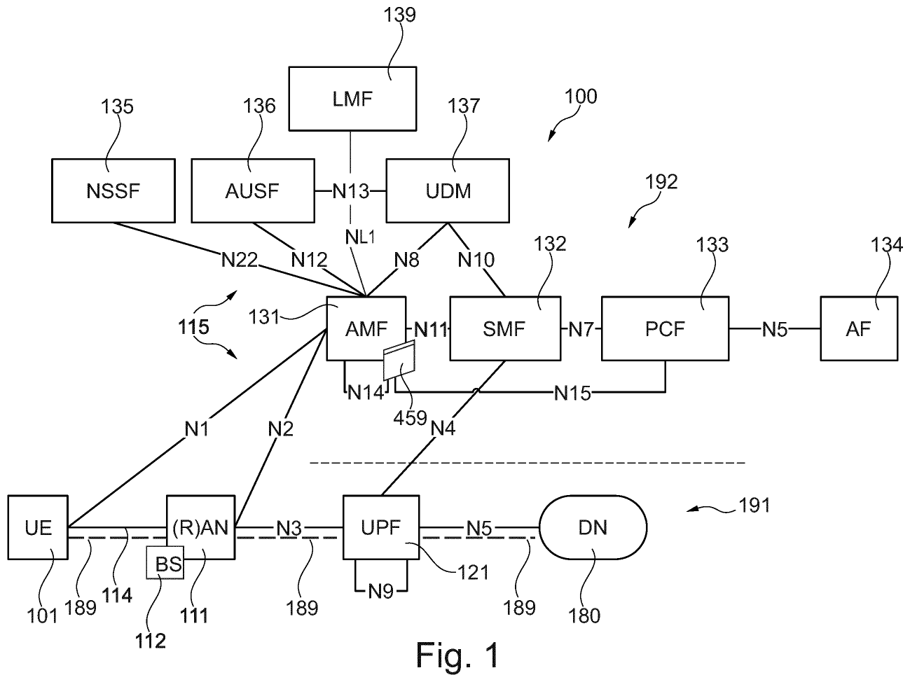

FIG. 1 schematically illustrates a cellular NW 100. The example of FIG. 1 illustrates the cellular NW 100 according to the 3GPP 5G architecture. Details of the 3GPP 5G architecture are described in 3GPP TS 23.501, version 15.3.0 (2017-09). While FIG. 1 and further parts of the following description illustrate techniques in the 3GPP 5G framework of a cellular NW, similar techniques may be readily applied to other communication protocols. Examples include 3GPP LTE 4G—e.g., in the MTC or NB-IOT framework—and even non-cellular wireless systems, e.g., an IEEE Wi-Fi technology.

In the scenario of FIG. 1, a UE 101 is connectable to the cellular NW 100. For example, the UE 101 may be one of the following: a cellular phone; a smart phone; an IOT device; a Machine Type Communication (MTC) device; a sensor; an actuator; etc.

The UE 101 is connectable to a core NW (CN) 115 of the cellular NW 100 via a RAN 111, typically formed by one or more BSs 112 (only a single BS 112 is illustrated in FIG. 1 for sake of simplicity). A wireless link 114 is established between the RAN 111—specifically between one or more of the BSs 112 of the RAN 111—and the UE 101.

The wireless link 114 implements a time-frequency resource grid. Typically, Orthogonal Frequency Division Multiplexing (OFDM) is used: here, a carrier includes multiple subcarriers. The subcarriers (in frequency domain) and the symbols (in time domain) then define time-frequency resource elements of the time-frequency resource grid. Thereby, a protocol time base is defined, e.g., by the duration of frames and subframes including multiple symbols and the start and stop positions of the frames and subframes. Different time-frequency resource elements can be allocated to different logical channels or reference signals of the wireless link 114. Examples include: Physical DL Shared Channel (PDSCH); Physical DL Control Channel (PDCCH); Physical UL Shared Channel (PUSCH); Physical UL Control Channel (PUCCH); channels for RA; etc.

The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data NW 180, e.g., the Internet or a Local Area NW. Application data can be communicated between the UE 101 and one or more servers on the data NW 180.

The cellular NW 100 also includes a mobility-control node, here implemented by an Access and Mobility Management Function (AMF) 131 and a Session Management Function (SMF) 132.

The cellular NW 100 further includes a Policy Control Function (PCF) 133; an Application Function (AF) 134; a NW Slice Selection Function (NSSF) 134; an Authentication Server Function (AUSF) 136; and a Unified Data Management (UDM) 137, and a location server node implemented by a location management function (LMF) 139. FIG. 1 also illustrates the protocol reference points N1-N22, NL1 between these nodes.

The AMF 131 provides one or more of the following functionalities: connection management sometimes also referred to as registration management; NAS termination for communication between the CN 115 and the UE 101; connection management; reachability management; mobility management; connection authentication; and connection authorization. For example, the AMF 131 controls CN-initiated paging of the UE 101, if the respective UE 101 operates in the idle mode. The AMF 131 may trigger transmission of paging signals, including a paging indicator and a paging message, to the UE 101; this may be time-aligned with paging occasions (POs).

After UE registration to the NW, the AMF 131 creates a UE context 459 and keeps this UE context, at least as long as the UE 101 is registered to the NW. The UE context 459 can hold one or more identities of the UE 101. The UE context 459 may hold an earlier location report provided by the UE 101. Alternatively or additionally, the earlier location report may also be stored in the LMF 139.

A data connection 189 is established by the SMF 132 if the respective UE 101 operates in the connected mode. The data connection 189 is characterized by UE subscription information hosted by the UDM 137. To keep track of the current mode of the UE 101, the AMF 131 sets the UE 101 to CM-CONNECTED or CM-IDLE. During CM-CONNECTED, a non-access stratum (NAS) connection is maintained between the UE 101 and the AMF 131. The NAS connection implements an example of a mobility control connection. The NAS connection may be set up in response to paging of the UE 101.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The LMF 139 manages the overall coordination and scheduling of resources required for the location update of a UE. The LMF 139 communicates using a PP. The LMF 139 can calculates or verify a final position and any velocity estimate and may estimate the achieved accuracy, based on a location report from the UE 101. The LMF 139 may receive location requests for the UE 101 from the serving AMF 131. The LMF 139 can interact with the UE 101 in order to provide configuration information, e.g., for PRSs.

The LMF 139 could determine the type of positioning measurement to be used by the UE 101. The LMF 139 could store location reports from the UE 101. The LMF 139 could store earlier positions of the UE 101. The LMF 139 may be located in the RAN 111 (not shown in FIG. 1).

It is conceivable that some functions of the LMF 139 are executed by other nodes. For example, it would be possible that a location request is provided by the AF 134, in additional or in alternative to location requests from the LMF 139.

The data connection 189 is established between the UE 101 via the RAN 111 and the UP 191 of the CN 115 and towards the DN 180. For example, a connection with the Internet or another packet data NW can be established. To establish the data connection 189, i.e., to connect to the cellular NW 100, it is possible that the respective UE 101 performs a RA procedure, e.g., in response to reception of a paging signal. A server of the DN 180 may host a service for which payload data is communicated via the data connection 189. The data connection 189 may include one or more bearers such as a dedicated bearer or a default bearer. For example, location-based services can rely on a location report from the UE 101. The data connection 189 may be defined on the RRC layer, e.g., generally Layer 3 of the OSI model.

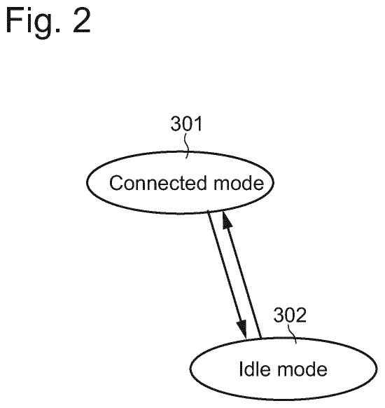

FIG. 2 illustrates aspects with respect to different modes 301-302 in which the UE 101 can operate. Example implementations of the operational modes 301-302 are described, e.g., in 3GPP TS 38.300, e.g., version 15.0.0.

During the connected mode 301, the data connection 189 is set up. For example, a default bearer and optionally one or more dedicated bearers may be set up between the UE 101 and the cellular NW 100. A wireless interface of the UE 101 may persistently operate in an active state, or may implement a DRX cycle including periodic switching between the active state and an inactive state.

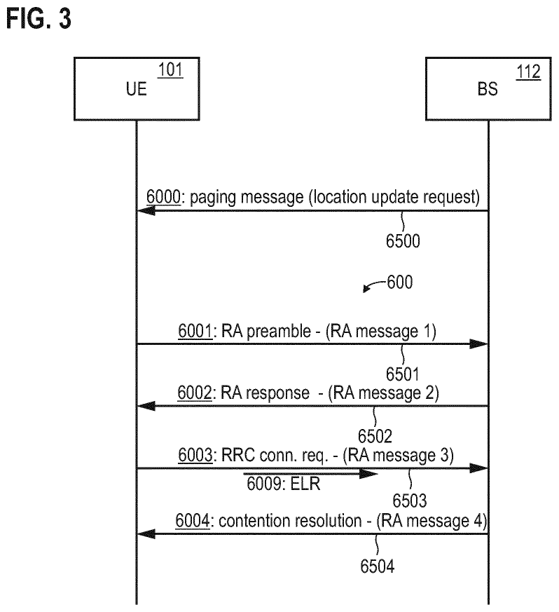

To achieve a power reduction, it is possible to implement the idle mode 302. Here, the UE 101 typically operates in accordance with a DRX cycle. The wireless interface of the UE 101 can be transitioned into an inactive state. The data connection 189 is released. Paging signals are transmitted to transition the UE 101 back into the connected mode 301, using a RA procedure. The idle mode 302 may or may not be transparent to the CN 115. The idle mode 302 could be implemented, e.g., by RRC_Inactive or RRC_Idle according to the 3GPP protocol. Details with respect to paging and the RA procedure are described in connection with FIG. 3.

FIG. 3 schematically illustrates aspects with respect to paging. FIG. 3 also illustrates aspects with respect to a RA procedure 600 according to various examples. FIG. 3 is a signaling diagram of communication between the UE 101 and the BS 112. FIG. 3 specifically illustrates aspects with respect to an ELR 6009 being transmitted by the UE 101.

Prior to initiating the RA procedure 600, the UE 101 may periodically listen to information blocks broadcasted by one or more BSs of the NW. For example, the broadcasted information blocks may include such information as a cell identity of the broadcasting BS. The UE 101 may monitor for paging indicators and paging messages. Blind decoding of the PDCCH for receiving the paging indicator can be implemented at a PO. When receiving the paging indicator, the paging message 6000 can subsequently be received, at 6500.

In the example of FIG. 3, the paging message 6000 is indicative of a request for the ELR 6009. This is generally optional, because, in other scenarios, such request may be included in the RAmsg2 6002 or may be omitted altogether, e.g., if the UE 101 triggers the transmission of the ELR 6009.

Upon receiving the paging message 6000 or depending on another trigger criterion (e.g., UE-initiated ELR), a connection establishment attempt may then be initiated using the RA procedure 600, which may include a non-contention-based procedure or a contention-based procedure. In typical case, the contention-based procedure may start with a four-step handshake protocol as shown in FIG. 3. Details are explained below.

At 6501, based on the broadcasted information, the UE 101 may transmit a RA preamble to the BS 112, in a respective RAmsg1 6001. This RAmsg1 6001 may be indicative of a temporary identity of the UE 101.

In some scenarios, the preamble code may be selected from a respective reserved partition associated with the upcoming ELR 6009. This reserved partition may be predefined or indicated in the broadcasted information. Thereby, the cellular NW 100 can be informed that the ELR 6009 is upcoming.

For example, in scenarios in which the positioning measurement involves DL PRSs, the cellular NW 100—e.g., the LMF 139—may be required to configure the transmission of the PRSs at the various BSs 112 of the RAN 100. Here, the indication of the upcoming ELR 6009 can be helpful to indicate, to the cellular NW 100, the currently serving BS 112. It would then be possible that transmission of PRSs is configured at the serving BS 112 and neighboring BSs 112, upon receiving the indication by means of the preamble partitioning. By providing this indication of the upcoming ELR 6009 early on as part of the RAmsg1 6001, it becomes possible to reduce the latency required for setting up the transmission of the PRSs. Thereby, timely completion of the positioning measurement is facilitated.

In response to transmitting the preamble, the UE 101 may receive, at 6502, a RA response message, the RAmsg2 6002. The RAmsg2 may include a new temporary identity for the UE 101, timing adjustment information, and an UL scheduling grant for time-frequency resources. The UL scheduling grant may be addressed to the UE's 101 RA Radio NW Temporary Identity (RA-RNTI).

Using these UL resources indicated by the UL scheduling grant included in the RAmsg2 6002, the UE 101 can send, at 6503, a RRC connection request RAmsg3 6003. For example, in the context of the 3GPP LTE protocol, the connection request may be native to the Radio Resource Control (RRC) layer of the transmission protocol stack, i.e., Layer 3 according to the Open System Interface (OSI) model. The RAmsg3 6003 may include a connection establishment cause. For example, in case of the ELR 6009, the connection establishment cause may be indicative of “location”.

In the example of FIG. 3, the RAmsg3 6003 includes In response to the RRC connection request 6003, the UE 101 may receive, at 6504, a contention resolution message RAmsg4 6004 to ensure the right UE is addressed. This RAmsg4 6004 may also be referred to as RRC connection setup message. This finalizes or aborts establishment of the data connection 189. For instance, if the ELR 6009 is successfully completed, it would then be possible to abort the establishment of the data connection 189. Thereby, the control signaling overhead associated with the location update can be reduced. In particular, it is not required to fully set up the data connection 189, because the ELR 6009 has already been transmitted.

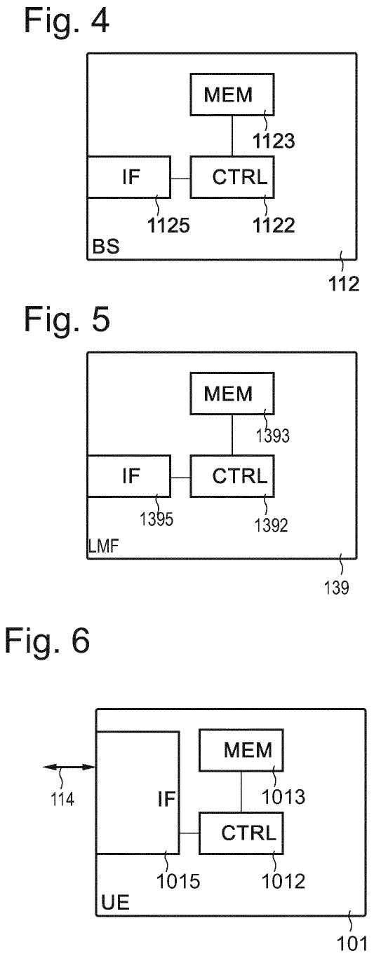

FIG. 4 schematically illustrates the BS 112 at greater detail. The BS 112 includes a control circuitry 1122, e.g., implemented by one or more processors. The control circuitry 1122 is coupled with a non-volatile memory 1123. Program code is stored on the memory 1123 and can be loaded and executed by the control circuitry 1122. Executing the program code causes the control circuitry 1122 to perform methods as described herein, e.g.: transmitting a paging message 6000 to the UE 101, e.g., the paging message 6000 being indicative of a request for the ELR 6009; participating in a RA procedure 600 with the UE 101, wherein one or more messages of the RA procedure 600 are associated with an location update of the UE 101; transmitting PRSs, e.g., in accordance with configuration information obtained from the LMF 139 or another CN node. For communicating on the wireless link 114 and/or with nodes of the core NW 115, the BS 112 includes an interface 1125.

FIG. 5 schematically illustrates the LMF 139 at greater detail. While FIG. 5 illustrates the LMF 139, other nodes of the cellular NW 100—e.g., the AF 134, etc.—can be configured similarly. The LMF 139 includes a control circuitry 1392, e.g., implemented by one or more processors. The LMF 139 also includes a non-volatile memory 1393 that is coupled with the control circuitry 1392. Program code is stored on the memory 1393 and can be loaded and executed by the control circuitry 1392. Executing the program code causes the control circuitry 1392 to perform methods as described herein, e.g.: transmitting a paging request message to a BS of the RAN 111, e.g., requesting a location update of the UE 101 being triggered by the BS 112 transmitting a paging message 6000 via the wireless link 114; receiving an ELR 6009 from the UE;

determining a position of the UE based on the ELR 6009; storing the ELR 6009 and/or the position of the UE 101, e.g., for later use in case the UE 101 is stationary and has a low mobility level; etc. For communicating with the various nodes and entities, the LMF 139 includes an interface 1395.

FIG. 6 schematically illustrates the UE 101 at greater detail. The UE 101 includes a control circuitry 1102, e.g., implemented by one or more processors. The UE 101 also includes a non-volatile memory 1013 that is coupled with the control circuitry 1012. Program code is stored on the memory 1013 and can be loaded and executed by the control circuitry 1012. Executing the program code causes the control circuitry 1012 to perform methods as described herein, e.g.: receiving a paging message, e.g., being indicative of a request for the ELR 6009; transmitting a RA preamble using a preamble sequence selected from a reserved partition; piggybacking information onto a RA control message, e.g., piggybacking an ELR 6009; performing a positioning measurement, e.g., based on UL and/or DL PRSs and/or satellite signals and/or accelerometer data; transitioning between the idle mode 302 and the connected mode 301; etc. For communicating on the wireless link 114, the UE 101 includes a wireless interface 1015.

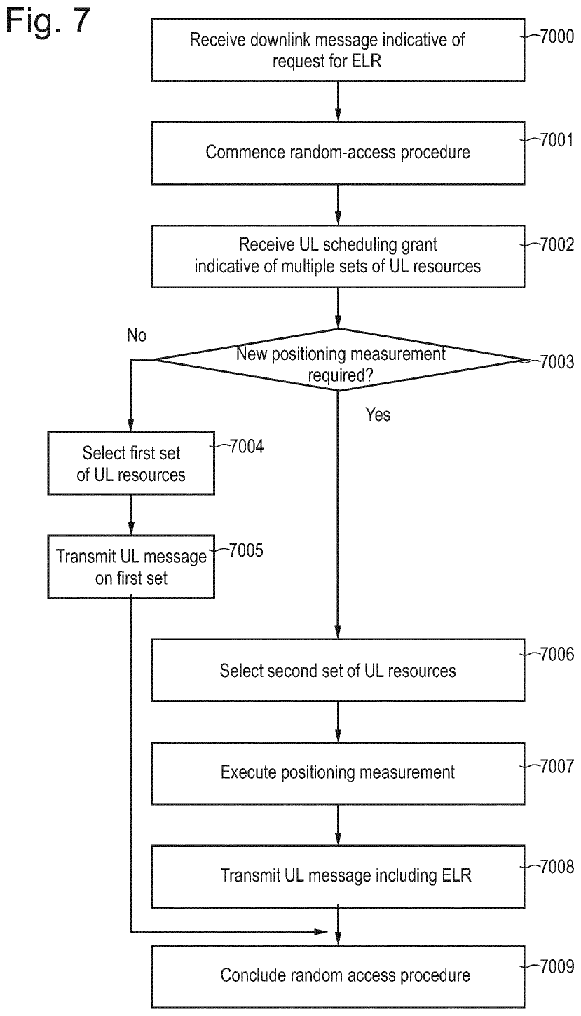

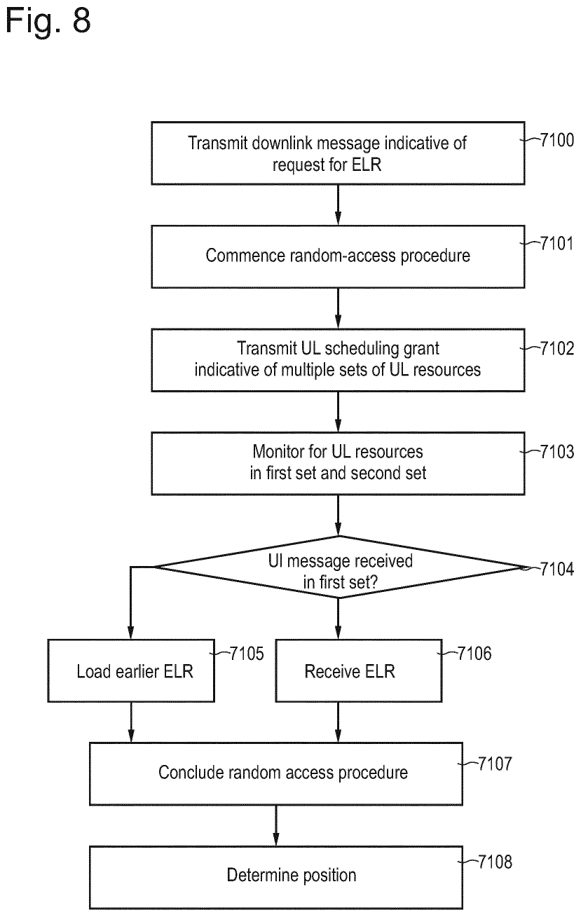

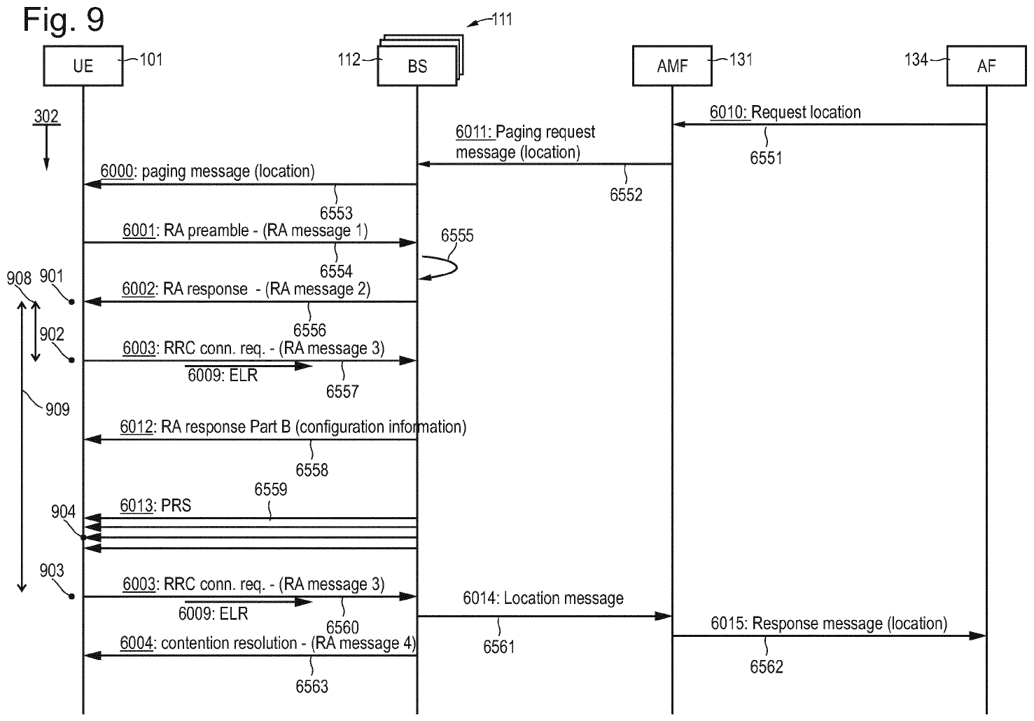

FIG. 7 is a flowchart of a method according to various examples. The method of FIG. 7 may be executed by a UE, e.g., the UE 101. For example, the method of FIG. 7 may be executed by a control circuitry of the UE, upon loading program code from a memory. The method of FIG. 7 may be used to implement the signaling illustrated in FIG. 3 or FIG. 9. The method of FIG. 7 is inter-related with the method of FIG. 8.

At optional box 7000, the UE receives a DL message that is indicative of a request for an ELR. For example, the DL message may be a paging message or a RAmsg2 or included in a broadcasted information block. By using a broadcast signaling, the cellular NW could indicate that it want all UEs—e.g., all UEs of a given category that may also be signaled in the broadcast signaling—to provide an ELR. Example UE categories include sensors, smart meters, etc. . . .

At box 7001, the UE starts a RA procedure. This includes transmitting a RAmsg1. (Note that in case the DL message of box 7000 is implemented by the RAmsg2, then, box 7001 is executed before box 7000). Box 7001 could be triggered by a paging message; or may be triggered by the UE. Sometimes, the UE may be configured to repetitively provide ELRs, e.g., according to a timing scheme.

At box 7002, the UE receives an UL scheduling grant. In the example of FIG. 7, the UL scheduling grant is indicative multiple sets of time-frequency resources. At least one of these sets can be used to transmit the ELR. For example, the UL scheduling grant may be included in the RAmsg2. The time-frequency resources of the sets can be offset in time domain from each other.

At box 7003, it is checked whether a new positioning measurement is required. For instance, it could be checked whether a mobility level of the UE is above a predefined threshold, or whether the UE can rather be assumed to be static. Alternatively or additionally, box 7003, it can be checked whether an earlier ELR is available in a memory. It can be checked whether this earlier ELR is still valid or is outdated, e.g., because the UE has moved. The freshness of an earlier ELR can be considered, e.g., whether it is outdated because too much time has elapsed, or it is outdated because the UE has moved, or it is outdated because the NW has deleted knowledge thereof, or UE has a new valid location ready to be sent due to, e.g., fast repetitive updates of the positioning measurements as part of location tracking, etc.

Then, based on such check, a selection between the multiple sets of time-frequency resources indicated by the UL scheduling grant of box 7002 can be performed. As such, said selecting may be based on the mobility level and/or the availability of a stored version of the ELR.

At box 7004, the first set of time-frequency resources is selected, for the transmission of the ELR. Box 7004 is executed if, at box 7003, it is judged that a new positioning measurement is not required.

At box 7005, accordingly, the stored version of the ELR is transmitted using an UL message, using the first set of time-frequency resources. For example, the ELR can be piggybacked to the RAmsg3, using EDT.

As a general rule, it is optional that, at box 7005, the stored version of the ELR is transmitted. In particular, a scenario is conceivable in which the stored version of the ELR is already available at the NW. Then, it may be sufficient to transmit the RAmsg3, e.g., within an indication that the NW-stored version of the ELR is still valid, or even without any explicit indication. As such, the ELR may be selectively included in the RAmsg3. In such case, the respective information field of the RAmsg3 may be left blank or include zero padding, etc. It may also be used otherwise, e.g., for UE-originating payload data, e.g., application data not related to positioning measurements.

At box 7009, the RA procedure is then concluded, e.g., by completing the establishment of the data connection or by aborting the establishment of the data connection, e.g., if the sole purpose for the RA procedure was the location update.

The ELR is included in the RAmsg3 (or another UL message transmitted as part of the RA procedure) when it is judged, at 7003, that a new positioning measurement is required. In this case, at box 7006, the second set of time-frequency resources is selected and, at box 7007, the positioning measurement is executed while the random-access procedure is ongoing, i.e., while the UE transitions from the idle mode towards the connected mode.

As a general rule, it would be possible that the type of the positioning measurement to be executed at box 7007 is configured by the NW. For example, it would be possible to receive a DL message that is indicative of the type of the positioning measurement to be used. More than a single positioning measurement may be used. For instance, it would be possible that the DL message received at box 7002—e.g., RAmsg2—is indicative of the type of the positioning measurement to be used. For instance, the type can be selected between a PRS-based positioning measurement and a non-PRS-based positioning measurement. In case a PRS-based positioning measurement is used, it would be possible that, during the RA procedure, configuration information for the PRSs is received. For instance, it would be possible that this configuration message is received at box 7002—e.g., as part of the RAmsg2 or in a DL message transmitted on time-frequency resources for which a corresponding DL scheduling assignment is included in the RAmsg2. By using the separate DL message, it is possible to accommodate for larger data sizes of the configuration information. Then, the PRSs can be received in accordance with the configuration information.

At box 7008, the ELR which is based on the positioning measurement of box 7007 is transmitted, e.g., piggybacked to the RAmsg3.

Then, box 7009 is executed, as already explained above.

FIG. 8 is a flowchart of a method according to various examples. The method of FIG. 8 may be executed by a NW node, e.g., by a BS and/or an LMF such as the BS 112 or the LMF 139. For example, the method of FIG. 8 may be executed by control circuitry upon loading program code from a memory. The method of FIG. 8 may be used to implement the signaling illustrated in FIG. 3 or FIG. 9. The method of FIG. 8 is inter-related with the method of FIG. 7.

Optional box 7100 corresponds to box 7000 (cf. FIG. 7). Here, transmission of a DL message to the UE is triggered or performed, wherein the DL message is indicative of a request for an ELR. For example, the DL message may be a paging message or a RAmsg2.

At box 7101, a RA procedure started. This can include receiving a RAmsg1. (Note that in case the DL message of box 7100 is implemented by the RAmsg2, then, box 7101 is executed before box 7100). Box 7101 corresponds to box 7001 (cf. FIG. 7).

At box 7102, an UL scheduling grant is transmitted which includes multiple sets of time-frequency resources. Box 7102 corresponds to box 7002.

At box 7103, the time-frequency resources and the multiple sets are monitor.

Accordingly, box 7104, it is decided whether an UL message—e.g., RAmsg3—is received in the first set (in which case box 7105 is subsequently executed), or is not received in the first set, but in the second set (in which case box 7106 is executed).

At box 7105—which corresponds to box 7005 (cf. FIG. 7)—an earlier ELR stored at the NW is loaded, e.g., from the LMF 139. For instance, this may be done because the use of the first set is (implicitly) indicative of a static position of the UE. It would be possible to release the second set of time-frequency resources, e.g., allocate them to another UE. It would also be possible that an ELR is included in the UL message received in the first set. This can be the case, e.g., where the UE has pre-provisioned an updated positioning measurement.

Otherwise, at box 7106, the ELR is received, e.g., piggybacked to the RAmsg3 in the second set of time-frequency resources. Box 7106 corresponds to box 7008 (cf. FIG. 7).

At box 7107 the RA procedures concluded. Box 7107 corresponds to box 7009 (cf. FIG. 7). The data connection establishment may be aborted.

At box 7108, the position of the UE is determined. This can include calculations based on the ELR, e.g., loaded as part of box 7105, or received as part of box 7106. For example, multilateration or other techniques may be employed. In other techniques, it is possible that the ELR is already indicative of the position such that at box 7108 no specific calculation measures need to be taken.

While in the scenarios of FIG. 7 and FIG. 8 examples have been described in which a selection between either the first set of time-frequency resources, or the second set of time-frequency resources is described, in other scenarios, it would be possible that, both, the first set of time-frequency resources, as well as the second set of time-frequency resources is used for transmission of, e.g., the RAmsg3. By such techniques, e.g., payload data using EDT can be combined with ELR, in the multiple instances of the RAmsg3 transmitted using the different sets time-frequency resources.

FIG. 9 is a signaling diagram of communication between the UE 101 and the cellular NW 100. FIG. 9 illustrates aspects with respect to an ELR 6009. The UE 101 initially operates in the idle mode 302.

At 6551, the cellular NW 100 triggers a location update. Here, the LMF 139 or another entity, e.g., the AF 134 or a NW Function, transmits a corresponding request control message 6010 to the AMF 131.

As a general rule, it is not required in all scenarios that the CN 115 triggers the location update. It would also be possible that the location update is triggered by the UE 101. It would also be possible that the location update is triggered by the RAN 114—e.g., this may be the case when operating in RRC_Inactive mode in which RAN-based mobility control is used.

At 6552, the AMF 131 then transmits a paging request message 6011 to the RAN 111. It would be possible that the paging request message 6011 includes a cause value, e.g., “location”, that is indicative of the request for the ELR 6009. It would be possible that the paging request message 6011 includes one or more sub-cause values, e.g., specifying the type of the positioning measurement to be executed by the UE 101 in order to provide the ELR 6009. For example, the sub-cause value indicative of the type of the positioning measurement could be set to “3GPP radio access technology” (for PRS-based positioning measurements” or to “other method for positioning measurement”. The type of the positioning measurement could also specify a required accuracy with which the location is to be determined.

Based on the paging cause value, the RAN 111 may include extra information in the paging message 6000 that is transmitted to the UE 101 at 6553. For example, the extra information could be indicative of the request for the ELR 6009. The extra information may specify the type of positioning measurement to be used.

The paging message 6000 may be transmitted by multiple BSs 112 of the RAN 111. For example, the paging message 6000 may be transmitted by BSs 112 within a tracking area or RAN update area (paging area). This is because the UE 101 may have moved while operating in the idle mode 302.

The paging message 6000 can be transmitted in accordance with a timing of POs of the UE 101, aligned with a discontinuous reception cycle.

Upon receiving the paging message 6000 at 6553, the UE responds to the RAN 111 with RAmsg1 6001, at 6554. Here, a preamble code of the RA-preamble can be selected from a respective reserved code partition, to indicate that the particular UE 101 responds to the paging message 6000 that is indicative of the request for the ELR 6009 (at 6554, contention between multiple UEs exists). The code partition can be reserved for UEs that intend to provide the ELR 6009. The RAN 111 can then determine that the RAmsg1 6001 received at 6554 is a response to the paging message 6000 transmitted at 6553.

In the example of FIG. 9, the RAN 111—upon receiving the RAmsg1 6001—hence has a rough estimate of the position of the UE 101. In particular, the RAN 111 can determine which cell the UE 101 is located, i.e., can determine the serving BS 112.

Then, at 6555, inter-BS 112 communication can be used in order to configure the transmission of DL PRSs 6013. For example, it would be possible that time-frequency resources of a time-frequency resource grid of the wireless link 114 are allocated for transmission of PRSs 6013 at the serving BS 112, as well as neighboring BSs 112 of cells adjacent to the cell of the serving BS 112. While such communication is illustrated in FIG. 9 to take place within the RAN, in other examples, it would be possible that the AMF 131 or another node of the core NW is involved. Such limitation of the BSs 112 transmitting the PRSs 6013 is possible because the RAN 111 has knowledge of the positioning of the UE 101 transmitting the upcoming ELR 6009 already upon receiving the RAmsg1 6001 having the respective preamble code in accordance with preamble partitioning.

The preamble partitioning explained above is generally optional. Other examples of distinguishing between UE's intending to provide the ELR 6009 and UE's that are attempting to connect to the cellular NW 100 for other reasons include: provisioning separate time-frequency resources for those two connection causes; resolving respective ambiguity later on, e.g., in RAmsg3, etc. For low-mobility UEs—e.g., smart-meters etc.—it may not be required to obtain the rough positioning estimate by using preamble partitioning. The position is fixed within a predetermined area, e.g., a single cell or a few cells. Also, it would be conceivable that instead of constraining the BSs 112 configured to transmit the PRSs 6013, all BSs 112 within the paging area are configured to transmit the PRSs 6013. In such a scenario, it may not be required to use the preamble partitioning.

Next, at 6556, the serving BS 112 transmits the RAmsg2 6002. The RAmsg2 6002 includes an UL scheduling grant, e.g., for transmission on the PUSCH. In the scenario of FIG. 9, the UL scheduling grant is indicative of two sets of time-frequency resources. A first set is for transmission of the RAmsg3 6003 at a time 902 and a second set is for transmission of the RAmsg3 6003 at a time 903, delayed with respect to the time 902. (cf. FIG. 7: box 7002 and FIG. 8: box 7102).

The RAmsg2 6002 is transmitted at the time 901. The time delay 908 between the time 901 of transmission of the RAmsg2 6002 and the time 902 of transmission of the RAmsg3 6003 is typically in the order of 3 to 10 milliseconds. Typical would be a time delay 908 corresponding to the duration of four subframes of the time base of the wireless link 114.

The time delay 909 between the time 901 and the time 903 is longer, e.g., in the range of 10 milliseconds to 500 milliseconds. This provides for sufficient time to execute the positioning measurement at 904.

In some examples, it would be possible that the cellular NW 100 dynamically adjusts the time delay 909. For example, it would be possible that the cellular NW 100 determines the time delay 909 depending on the type of the positioning measurement to be executed by the UE 101. Such techniques are based on the finding that different types of positioning measurements may require different amount of time to be completed. It would be generally possible that the paging message 6000 and/or the RAmsg2 6002 is indicative of the type of the positioning measurement.

In the scenario of FIG. 9, the RAmsg2 6002 also includes a DL scheduling assignment that is indicative of time-frequency resources used for transmitting a further DL control message 6012. The further DL control message 6012 may be viewed as an extension to the RAmsg2 6002 (hence labeled “RA response part B” in FIG. 9). If the information content of the further DL control message 6012 fits into the RAmsg2 6002, then it may not be necessary to separately transmit the further DL control message 6012; instead, this information content can be directly included in the RAmsg2 6002.

The further DL control message 6012 transmitted by the serving BS at 6558 includes configuration information for the positioning measurement, here for receiving the PRSs 6013. The configuration information may, e.g., include a list of BSs 112 of the RAN 111 transmitting the PRSs 6013. This list—or, more generally, the configuration information—can be determined based on the serving BS 112, i.e., in accordance with the rough positioning estimate and in accordance with the signaling at 6555.

The configuration information may include an indication of the time-frequency resources allocated for the transmission of the PRSs 6013, e.g., for each BS 112 on the list.

The configuration information may include timing offset between the protocol time base of the wireless links 114 supported by the BSs 112 on the list. The beginning of subframes of the same sequence number may be shifted with respect to each other, in accordance with this timing offset.

The UE, upon receiving the RAmsg2 6002, may then determine whether a new positioning measurement needs to be executed, or whether an earlier version of the location report is still valid or whether an updated positioning measurement has been recently pre-executed before receiving the RAmsg2 6002 such that its result can be assumed to valid (typical validity durations of the positioning measurement may correlate with a time scale of the mobility level of the UE). This decision can be based on, e.g., a mobility level of the UE and the availability of the earlier version of the location report, e.g., stored at the NW 100 or at the UE 101. Depending on such in other decision criteria, the UE 101 can then select between the first set of time-frequency resources as indicated by the UL scheduling grant included in the RAmsg2 6002 and the second set of time-frequency resources as indicated by the UL scheduling grant in the RAmsg2 6002. For example, in case a new execution of the positioning measurement is not required, then the first set of resources can be selected and the RAmsg3 6003 can be transmitted at 6557, using the shorter time delay 908. Here, a corresponding indication may be included in the RAmsg3 6003 that an earlier version of the location report is still valid. Also, it would be possible (as illustrated in FIG. 9) to include the stored version of the location report as the ELR 6009.

Otherwise, the UE will receive the configuration information for the transmission of the PRSs 6013, and subsequently, at 6559, monitors for the DL PRSs 6013, in accordance with the configuration information. The PRSs 6013 are transmitted by the BSs 112 of the RAN 100 in accordance with the configuration information.

While in FIG. 9 a scenario is illustrated in which the positioning measurements based on PRSs 6013, in other scenarios, another type of positioning measurement may be used, not relying on the transmission of the PRSs 6013. Also, in such scenarios, NW-assistance by means of a respective configuration information may be provided, as illustrated in FIG. 9. In other scenarios, providing the configuration information may not be required and then it is not required to transmit, e.g., the further DL message 6012.

Upon completing the execution of the positioning measurement, the UE 101 transmits the ELR 6009 that is based on the positioning measurement executed at 904 in parallel to the RA procedure 600, while transitioning from the idle mode 602 towards the connected mode 601. The ELR 6009 may already include the position of the UE 101, or may include measurement values of the positioning measurements based on which the cellular NW 100 can determine the position.

At 6561 and 6562, a location message 6014 and a response message 6015 is transmitted from the RAN 111 to the AMF 113 and onwards to the LMF 139 (or another node), respectively. This can be in accordance with a positioning protocol.

The serving BS 112 can acknowledge the receipt of the ELR 6009 in the RAmsg4 6004. The cellular NW 100 can decide whether the transition towards the connected mode 301 is to be completed by finalizing the establishment of the data connection 189, or whether the transition towards the connected mode 301 is to be aborted and the UE 101 should transition back to the idle mode 302 by aborting the establishment of the data connection 189. The RAmsg4 6004 can be configured accordingly.

Summarizing, above, techniques for a fast location update have been described. In particular, techniques have been described which facilitate configuring the UE for performing a positioning measurement—e.g., by reception of PRSs—even before the UE has completed a transition from operation in the idle mode to operation in the connected mode. This can be achieved by providing configuration information for the positioning measurement by including a DL scheduling assignment to receive the configuration information in the RAmsg2 of the RA procedure for transitioning from the idle mode towards the connected mode. This scheduling assignment could be implemented by a DL Control Information that points towards the time-frequency resources that will include the configuration information for the positioning measurements.

To facilitate execution of the positioning measurement while transitioning from the idle mode towards the connected mode, the cellular NW can postpone/delay the timing of the transmission of the RAmsg3 if compared to reference implementations. Then, the location report can be piggybacked to the delayed RAmsg3. Reference implementations use a delay between the RAmsg2 including the UL scheduling grant for transmission of the RAmsg3 that is 3-4 subframes, i.e., 3-4 milliseconds, long. In the scenarios described here, the RAmsg2 can include the UL scheduling grant for transmission of the RAmsg3 at a delay of a few tens of milliseconds or up to 500 ms.

The RAmsg2 or even a paging message may also be indicative of a type of the positioning measurement to be used, e.g., whether to use or not use DL PRSs transmitted by the cellular NW.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various techniques have been described in the context of a 4-step RA procedure. Similar techniques may also be applied in the context of a 2-step RA procedure.

For still further illustration, various techniques have been described in the context of a type of positioning measurements relying on the reception of DL PRSs at the UE. Other types of positioning measurements may be employed, including a type of positioning measurements that relies on the transmission of UL PRSs to the NW.

For still further illustration, various examples have been described for a scenario in which RAmsg2 includes multiple sets of resources allocated for uplink transmission of RAmsg3. This is generally optional. In other scenarios, a single set of resources—e.g., delayed if compared to reference implementations—may be indicated. Where multiple sets of time-frequency resources are indicated, this can be done using a single UL scheduling grant or multiple UL scheduling grants.

For still further illustration, various examples have been described in which the RAmsg2 includes multiple sets of resources allocation for UL transmission of RAmsg3. Scenarios have been described in which the UE selects the second (later) set upon determining that an ELR is to be provided. In other examples, an ELR may be provided using RAmsg3 transmitted on the first set of resources. This may be possible, e.g., in cases in which the UE has recently executed a positioning measurement that is still valid and can use the respective results as the ELR. Then, it may not be required to re-execute the positioning measurement and the ELR can, without significant delay, be transmitted using the early RAmsg3 on the first set of time-frequency resources. See, e.g., Table 1, example C. In this regard, in some scenarios the UE may even indicate to the NW that it has pre-executed the positioning measurement and/or has an up-to-date ELR available. For example, this could be done using a respective code partition of the RA preamble. Also, respective information may be included in the UE context of that UE. Alternatively or additionally, respective information may be derived from a UE category.

For still further illustration, in some examples the UE may indicate, to the cellular NW, in the RAmsg1 that an earlier version of the ELR—available at the cellular NW—is still valid. This may be, in particular, the case upon receiving a paging message or a broadcasted DL signaling from the cellular NW including a request for an ELR. In such as scenario, the cellular NW may not even be required to respond to the RAmsg1 with a RAmsg2. The earlier ELR may be loaded from a respective repository at the cellular NW, as explained above.

For still further illustration, while various techniques have been described for an ELR triggered by the NW, e.g., by a respective cause value in the paging message, similar techniques may be applicable to a UE-originating ELR.

For still further illustration, various examples have been described in which the ELR is transmitted during the RA procedure. In some other examples, it would be possible that—while the ELR is still triggered during or before the RA procedure, e.g., by transmitting a paging message or RAmsg2 indicative of a request for the ELR, and while the positioning measurement is still performed while transitioning from idle mode to connected mode—the ELR itself is transmitted after completion of the RA procedure. For example, the ELR may be transmitted along the data connection in connected mode using resources scheduled on the PUSCH, e.g., using an RRC control message. The ELR may be transmitted piggybacked to the RAmsg5 confirming the establishment of the data connection.

1. A method of operating a wireless communication device attachable to a communications network, the method comprising:
receiving a message from the communications network, the message being indicative of a request for a location report of the wireless communication device, and
upon receiving the message and based on a positioning measurement, transmitting an uplink message of a random-access procedure of the wireless communication device the uplink message comprising the location report.

2. The method of claim 1, wherein the message is a paging message triggering the random-access procedure.

3. The method of claim 2, further comprising:
upon receiving the paging message, transmitting a random-access preamble of the random-access procedure, wherein a preamble code of the random-access preamble is selected from a reserved code partition indicative of the location report.

4. The method of claim 1, wherein the message is a random-access downlink message of the random-access procedure triggered by a random-access preamble transmitted by the wireless communication device.

5. The method of claim 1, wherein a random-access downlink message of the random-access procedure triggered by a random-access preamble of the random-access procedure transmitted by the wireless communication device comprises an uplink scheduling grant for the uplink message of the random-access procedure, wherein the uplink message is transmitted in accordance with the uplink scheduling grant.

6. The method of claim 5, wherein the uplink scheduling grant is indicative of a first set of time-frequency resources and a second set of time-frequency resources delayed and offset in time domain with respect to the first set of time-frequency resources.

7. The method of claim 6, wherein the method further comprises:
selecting between the first set of time-frequency resources and the second set of time-frequency resources for transmitting the uplink message of the random-access procedure.

8. The method of claim 7, wherein said selecting between the first set of time-frequency resources and the second set of time-frequency resources depends on at least one of a mobility level of the wireless communication device, availability of a stored version of the location report.

9. The method of claim 7, wherein the location report is selectively included in the uplink message of the random-access procedure upon selecting the second set of time-frequency resources.

10. The method of claim 1,
wherein a random-access downlink message of the random-access procedure triggered by a random-access preamble of the random-access procedure transmitted by the wireless communication device is indicative of a type of the positioning measurement,
wherein the type of the positioning measurement is selected from a first type of positioning measurements using positioning reference signals transmitted by the communications network and a second type of positioning measurements not using the positioning reference signals transmitted by the communications network.

11. The method of claim 1, further comprising:
receiving, during the random-access procedure configuration information of positioning reference signals, and
receiving the positioning reference signals in accordance with the configuration information.

12. The method of claim 11, wherein a random-access downlink message of the random-access procedure triggered by a random-access preamble transmitted by the wireless communication device comprises the configuration information or comprises a downlink scheduling assignment for a downlink configuration message comprising the configuration information.

13. The method of claim 11, wherein the configuration information comprises a list of access nodes of the communications network transmitting the positioning reference signals, wherein the configuration information optionally comprises at least one of time-frequency resources allocated for the transmission of the positioning reference signals at the access nodes, or timing offsets for the access nodes.

14. The method of claim 1, wherein a time delay between a random-access downlink message of the random-access procedure triggered by a random-access preamble transmitted by the wireless communication device and said transmitting of the uplink message is in the range of 10 milliseconds to 5 seconds, optionally to 500 milliseconds.

15. The method of claim 1, further comprising:
upon transmitting the uplink message of the random-access procedure, receiving a further downlink message of the random-access procedure indicative of an aborted connection establishment.

16. The method of claim 1, further comprising:
executing the positioning measurement while transitioning from operating the wireless communication device in an idle mode towards operating the wireless communication device in a connected mode.

17. A method of operating a node of a communications network, the method comprising:
transmitting a message to a wireless communication device, the message being indicative of a request for a location report of the wireless communication device, and
upon transmitting the message, receiving an uplink message of a random-access procedure of the wireless communication device, the uplink message comprising the location report.

18. The method of claim 17, further comprising:
transmitting, during the random-access procedure, configuration information of positioning reference signals, and
receiving and/or transmitting the positioning reference signals in accordance with the configuration information.

19. The method of claim 18, further comprising:
determining the configuration information based on a serving access node of the communications network that receives a random-access preamble from the wireless communication device.

20. (canceled)

21. A wireless communication device attachable to a communications network, the wireless communication device comprising control circuitry, wherein the control circuitry is configured to:
receive a message from the communications network, the message being indicative of a request for a location report of the wireless communication device, and
upon receiving the message and based on a positioning measurement, transmit an uplink message of a random-access procedure of the wireless communication device, the uplink message comprising the location report.

22. (canceled)
